(19) United States
(12) Patent Application Publication
(10) Pub. No.: US 2009/0024375 A1
(43) Pub. Date: Jan. 22, 2009

(54) METHOD, SYSTEM AND COMPUTER PROGRAM PRODUCT FOR LEVINTHAL PROCESS INDUCTION FROM KNOWN STRUCTURE USING MACHINE LEARNING

(75) Inventors: Stefan Kremer, Guelph (CA); Hao Lac, Guelph (CA)

Correspondence Address: BERESKIN AND PARR, 40 KING STREET WEST, BOX 401, TORONTO, ON, M5H 3Y2, CA

(73) Assignee: University of Guelph, Guelph (CA)

(21) Appl. No.: 12/116,558

(22) Filed: May 7, 2008

Related U.S. Application Data
(60) Provisional application No. 60/916,430, filed on May 7, 2007.

(51) Int. Cl. G06G 7/58

(52) U.S. Cl. 703/11

(57) ABSTRACT

A method is provided for predicting the structure of a macromolecule by modeling the folding process from the unfolded to the folded state based on machine learning a training set of known structures.

### CROSS-REFERENCE TO RELATED APPLICATION

This is a non-provisional application of U.S. application No. 60/916,430 filed May 7, 2007. The contents of U.S. application No. 60/916,430 are incorporated herein by reference.

### FIELD OF THE INVENTION

This application relates to a method for predicting the 3-dimensional structure of a macromolecule. More specifically, the application discloses a method for determining relative atomic coordinates of a molecule using a machine learning process trained on a series of known structures that identifies an iterative analog of the folding of a macromolecule.

### BACKGROUND OF THE INVENTION

Detailed knowledge of the 3-dimensional structure of macromolecules such as proteins is invaluable for tasks that require an understanding of structure-activity relationships such as rational drug design, identifying active sites and binding sites, modeling substrate specificity and predicting antigenic epitopes.

While efforts such as the Human Genome Project have produced massive amounts of protein sequence data, the discovery of experimentally determined protein structures—typically by time-consuming and relatively expensive X-ray crystallography or NMR spectroscopy—is lagging far behind the output of protein sequences.

The prediction of a macromolecule's 3-dimensional structure based on its sequence is an extremely difficult task due to the very large number of degrees of freedom and accordingly vast number of possible conformations in biological molecules such as proteins. A 150-residue protein has about 10³⁰⁰ possible conformations, yet many small proteins fold spontaneously on a millisecond or even microsecond time scale. Levinthal observed that if a protein is to attain its correctly folded configuration by sequentially sampling all the possible conformations, it would require a time longer than the age of universe to arrive at its correct native conformation (See for example, R Zwanzig, A Szabo, and B Bagchi, “Levinthal's Paradox”, Proceedings of the National Academy of Sciences, Vol. 89, pp.20-22, 1992.). This is true even if conformations are sampled at rapid (nanosecond or picosecond) rates, resulting in what is known as the Levinthal paradox. In general, molecules with n atoms have 3n-6 degrees of freedom. For a protein of 100 residues this amounts to approximately 6000 degrees of freedom. Systems of equations with this number of variables are currently analytically intractable.

The prediction of the structure of a macromolecule such as a protein is further hampered by the fact that the physical or chemical basis of protein stability is not well understood. A particular protein sequence may be able to assume multiple conformations depending on its environment. Additionally, the biologically active conformation is not necessarily the one that is most thermodynamically favourable or at a global free energy minimum.

Two major classes of methods for predicting structure are known in the art. The first consists of de novo methods that do not rely on the known 3D structures of studied molecules, but instead use a population of candidate sub-structures whose free energies are known (See for example, D. Baker and A. Sali. Protein structure prediction and structural genomics. SCIENCE, 294:93-96, October 2001). By surveying permutations of the known sub-structures until a global free energy minimum is found, a putative structure for a molecule is identified. Hence, de novo methods are distinguished by (i) the need for accurate energy functions for the sub-structures and their combination, and (ii) a search algorithm to carry out a large-scale search of the conformational space for protein tertiary structures that are low in free energy. Even with an optimized search algorithm, de novo methods are limited to very small molecules due to the extremely large degrees of freedom of longer chains. Moreover, as noted, the native structure or conformation of a biologically active molecule is not always at the global free energy minimum.

Second, comparative modeling techniques rely on measuring the detectable similarity between the modeled sequence and that of at least one other sequence with a known structure, which is used as a template for the prediction process (See for example, A. Fiser, R. Sánchez, F. Melo, and A. Sali. Comparative protein structure modeling. In M. Watanabe, B. Roux, A. MacKerell, and O. Becker, editors, Computational Biochemistry and Biophysics, chapter 7, pages 275-312. Marcel Dekker, 2000). To determine whether a given sequence is similar to the modeled sequence, sequence alignment algorithms are used. This approach is limited by: (i) the need to determine a correct gap-penalty model for the purposes of alignment between the modeled sequence and a sequence with known structure, (ii) the need to correctly model regions where no information is available due to gaps inserted during alignment, (iii) the need for sequence identity above 40% identity to avoid significant error due to misalignment.

Chapman et al. (U.S. Pat. No. 5,526,281) describe machine learning techniques for predicting biological activity and other characteristics of molecules. Chapman et al. use a surface representation of molecular structures and focus on adjusting the network weights to reflect only the best “pose” of a given macromolecule that may possibly be for an active binding site. That is, they focus only on the end result of the folding process to find what the “best pose” of a macromolecule is and then adjust the network weights to reflect this “best pose”.

There is therefore a need for computationally feasible methods for predicting the atomic structure of biological molecules that do not rely on de novo methods using energy functions or comparative modeling techniques that require matching algorithms.

### SUMMARY OF THE INVENTION

This application relates generally to a method for determining the structure of a macromolecule using iterative machine learning methods that model folding pathways of a given set of known structures. As used herein, “structure” refers to a molecule's conformation in 3-dimensional space; “known structure” refers to a stable or native structure of a macromolecule that has been experimentally determined.

The inventors disclose that the use of a function determined using machine learning methods that models the projected folding paths of a training series of known macromolecules are useful for the prediction of structures for macromolecules for which only the primary sequence is known.

Accordingly, in one embodiment the invention includes a method for modeling the structure of a macromolecule based on the primary sequence of that macromolecule, the method comprising: selecting a training set of known macromolecules, wherein each known macromolecule of the training set has a known structure and a known primary sequence; defining an initialized structure for each known macromolecule of the training set based on its primary sequence; for each known macromolecule of the training set, defining a corresponding projected folding path comprising a progression of n projected macromolecule states, beginning with the initialized structure and ending with the known structure, wherein n is a positive integer greater than 2, wherein each macromolecule state in the n macromolecule states has a corresponding primary sequence, and a state-specific projected structure; providing a function operable to, for each known macromolecule of the training set, define a corresponding modeled folding path approximating the corresponding projected folding path, wherein: i) the corresponding modeled folding path comprises a progression of n modeled macromolecule states, beginning from the initialized structure and ending with the known structure, ii) each modeled macromolecule state in the n macromolecule states has the primary sequence and a state-specific modeled structure, and iii) the function is operable to, for each modeled macromolecule state progression of n modeled macromolecule states except the last modeled macromolecule state, translate the state-specific structure of any macromolecule state in the corresponding folding path into the state-specific structure of the immediately following macromolecule state in the progression.

In a further embodiment, the invention further includes selecting a new macromolecule having a known primary sequence and defining an initialized structure for the new macromolecule and applying the function to the known primary sequence and the initialized structure for the new macromolecule to predict the structure of the new macromolecule.

In another embodiment of the invention, a system is provided for modeling the structure of a macromolecule based on the primary sequence of that macromolecule, the system comprising: a memory for storing a training set of known macromolecules, wherein each known macromolecule of the training set has a known structure and a known primary sequence; a processor module for a) determining an initialized structure for each known macromolecule of the training set based on its primary sequence; b) for each known macromolecule of the training set, defining a corresponding projected folding path comprising a progression of n projected macromolecule states, beginning with the initialized structure and ending with the known structure, wherein n is a positive integer greater than 2, wherein each macromolecule state in the n macromolecule states has a corresponding primary sequence, and a state-specific projected structure; c) providing a function operable to, for each known macromolecule of the training set, define a corresponding modeled folding path approximating the corresponding projected folding path, wherein i) the corresponding modeled folding path comprises a progression of n modeled macromolecule states, beginning from the initialized structure and ending with the known structure, ii) each modeled macromolecule state in the n macromolecule states has the primary sequence and a state-specific modeled structure, and iii) the function is operable to, for each modeled macromolecule state progression of n modeled macromolecule states except the last modeled macromolecule state, translate the state-specific structure of any macromolecule state in the corresponding folding path into the state-specific structure of the immediately following macromolecule state in the progression.

In a further embodiment, the memory is further operable to store a new macromolecule and a known primary sequence for the new macromolecule; and the processor module is further operable to determine an initialized structure for the new macromolecule, and then apply the function to the known primary sequence and the initialized structure for the new macromolecule to determine the structure of the new macromolecule.

In another embodiment of the invention, there is provided a computer program product for configuring a computer system to predict the structure of a macromolecule based on the primary sequence of the macromolecule, the computer program product comprising: a recording medium; a function saved on the recording medium for predicting the structure of the macromolecule using a training set of macromolecules wherein the function has been generated by a method comprising: a) defining an initialized structure for each known macromolecule of the training set based on its primary sequence; b) for each known macromolecule of the training set, defining a corresponding projected folding path comprising a progression of n projected macromolecule states, beginning with the initialized structure and ending with the known structure, wherein n is a positive integer greater than 2, wherein each macromolecule state in the n macromolecule states has a corresponding primary sequence and a state-specific projected structure; c) providing a function operable to, for each known macromolecule of the training set, define a corresponding modeled folding path approximating the corresponding projected folding path, wherein i) the corresponding modeled folding path comprises a progression of n modeled macromolecule states, beginning from the initialized structure and ending with the known structure, ii) each modeled macromolecule state in the n macromolecule states has the primary sequence and a state-specific modeled structure, and iii) the function is operable to, for each modeled macromolecule state progression of n modeled macromolecule states except the last modeled macromolecule state, translate the state-specific structure of any macromolecule state in the corresponding folding path into the state-specific structure of the immediately following macromolecule state in the progression.

### BRIEF DESCRIPTION OF THE DRAWINGS

FIG. 1 presents one embodiment of a training procedure for a learning system.

FIG. 2 presents one embodiment of a testing procedure for the prediction of the structure of a macromolecule using the trained learning system.

FIG. 3 presents a detailed schematic for one embodiment of a training procedure.

FIG. 4 shows an example of Relative Spatial Measures for a given molecule consisting of torsion angle, bond angle, and bond length.

FIG. 5 shows one embodiment of an input vector for the physical-chemical properties of a given residue.

FIG. 6 provides a summary diagram of amino acid properties.

FIG. 7 shows possible neighborhoods for one embodiment of an input vector for a given reference atom.

FIG. 8 provides an illustration of one embodiment of an input vector.

FIG. 9 presents a detailed schematic of one embodiment of a testing procedure.

FIG. 10 illustrates the relationship between an input vector and an output vector for an ensemble of multiple networks.

FIG. 11 shows the relationship between an angle in radians and the network output.

FIG. 12 is a schematic of one embodiment of the invention showing prediction using a collection of ensemble networks.

FIG. 13 is a schematic of one embodiment of the invention showing the combined learning and exploration of the conformation space.

FIG. 14 in a block diagram, illustrates a computer system for configuring to implement an embodiment of the invention.

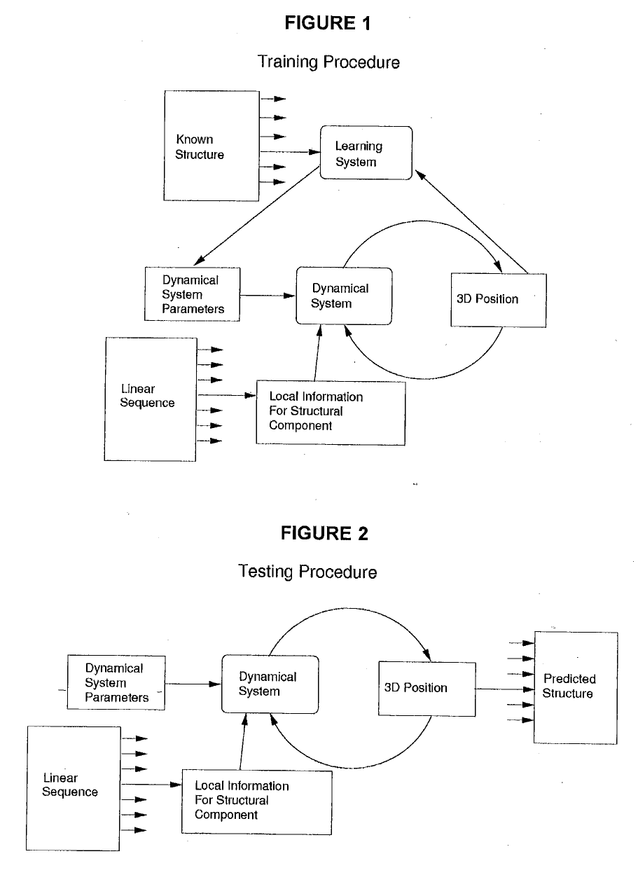

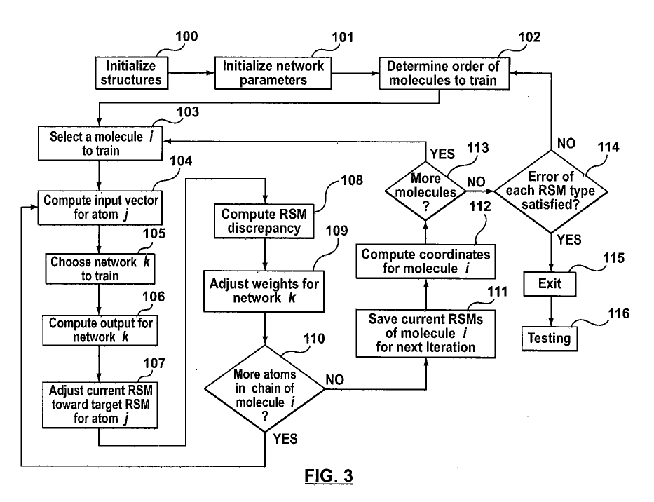

### DETAILED DESCRIPTION OF THE INVENTION

The applicants describe a method to predict macromolecular structures by inducing the Levinthal process from an unfolded state to the folded state based on machine learning systems using known structures. The method attempts to model the way real structures fold using data induced from known structures without an explicit matching process. In one embodiment, proteins for which the structure is known are presented to the machine learning system in an unfolded state and are dynamically folded into their native conformations. In a further embodiment, the steps from unfolded to folded state for all proteins in a training set are learned by the system, and a prediction of a modeled sequence from its unfolded state utilizes the learned dynamics to fold the structure of the modeled sequence to its final conformation.

In one embodiment, the process by which a macromolecule attains its folded structure is treated as a dynamical system. The dynamical folding process of a macromolecule is essentially a continuous process; however, by taking discrete “snapshots” of its configuration as it folds through time and learning this dynamic, the folding problem can be recast as a function approximation problem where the function best describes the pathways taken by macromolecules from their unfolded state to their folded state. As used herein “function” refers to an association between the elements of two sets. A further embodiment of the invention iteratively refines the structure of macromolecules from an unfolded state to a native conformation, and in doing so uses machine learning techniques to learn folding dynamics which are then used to predict the structure of macromolecules with unknown structure. Examples of machine learning techniques are described in: Christopher M. Bishop (2007) Pattern Recognition and Machine Learning, Springer ISBN 0-387-31073-8; Bishop, C. M. (1995). Neural Networks for Pattern Recognition, Oxford University Press. ISBN 0-19-853864-2; Richard O. Duda, Peter E. Hart, David G. Stork (2001) Pattern classification (2nd edition), Wiley, New York, ISBN 0-471-05669-3; MacKay, D. J. C. (2003); Information Theory, Inference, and Learning Algorithms, Cambridge University Press. ISBN 0-521-64298-1; and Mitchell, T. (1997) Machine Learning, McGraw Hill. ISBN 0-07-042807-7 which are hereby incorporated by reference.

In one embodiment, the inventors describe a method for predicting the structure of a macromolecule based on the primary sequence of that macromolecule. As used herein “macromolecule” refers to a molecule including, but not limited to conventional polymers or biopolymers (e.g. polypeptides, proteins, RNA, DNA or carbohydrates) as well as non-polymeric molecules with large molecular mass such as lipids or macrocycles. As used herein, “primary sequence” refers to an ordered sequence of atoms or other subunits that comprise a macromolecule. In one embodiment, a primary sequence for a protein would be a linear sequence of amino acids. A subunit refers to a portion of a macromolecule; depending on the desired resolution and application of the method, in some embodiments a subunit could correspond to an amino acid, carbohydrate residue, nucleic acid or atom.

In one embodiment the method relates to predicting the structure of a protein or polypeptide molecule based on its primary sequence. In other embodiments, the method is used to predict protein sub-structures or secondary structures. In further embodiments, the methods are used to predict the structures of macromolecules such as DNA, RNA, carbohydrates or glycoproteins or portions thereof.

In one embodiment, the invention relates to a method for modeling the structure of a macromolecule based on the primary structure of that macromolecule.

In some embodiments, the method comprises selecting a training set of known macromolecules or subunits of macromolecules, wherein each known macromolecule of the training set has a known structure and a known primary sequence. As used herein a “training set” refers to a group of macromolecules for which both the primary sequence and a 3-dimensional structure are known that is used to extract generalized rules for application to other data.

In another embodiment, an initialized structure for each known macromolecule of the training set based on its primary sequence is defined. As used herein, an “initialized structure” refers to an assumed structure of a macromolecule.

In a further embodiment, for each known macromolecule of the training set, a corresponding projected folding path is defined comprising a progression of n projected macromolecule states, beginning with the initialized structure and ending with the known structure, wherein n is a positive integer greater than 2. Each macromolecule state in the n macromolecule states has a corresponding primary sequence, and a state-specific projected structure. In some embodiments n can range from 2 to 30. In one embodiment, n is equal to 20.

In one embodiment, the projected folding path is defined using linear interpolation between the initialized structure and its corresponding known structure to generate n-projected macromolecule states. A person skilled in the art will appreciate that additional methods may be used to define a projected folding path for a macromolecule.

In a further embodiment, for each known macromolecule of the training set, a set of structures are defined along with an appropriate incremental change towards the folded state of the macromolecule.

In a further embodiment, a function is provided operable to, for each known macromolecule of the training set, define a corresponding modeled folding path approximating the corresponding projected folding path. The corresponding modeled folding path comprises a progression of n modeled macromolecule states, beginning from the initialized structure and ending with the known structure. Each modeled macromolecule state in the n macromolecule states has the primary sequence of the corresponding macromolecule in the training set and a state-specific modeled structure. The function is operable to, for each modeled macromolecule state progression of n modeled macromolecule states except the last modeled macromolecule state, translate the state-specific structure of any macromolecule state in the corresponding folding path into the state-specific structure of the immediately following macromolecule state in the progression.

In one embodiment of the invention, the function is provided using machine learning. In some embodiments of the invention, the function is provided using artificial neural networks. In another embodiment, the artificial neural network is replaced by a Support Vector Machine (SVM) for regression (“Support Vector Regression Machines” (1996), Harris Drucker, Chris J. C. Burges, Linda Kaufman, Alex Smola, Vladimir Vapnik, Advances in Neural Information Processing Systems 9).

In other embodiments, additional methods for adjusting the parameters of the model include Alopex, quasi-Newton methods, genetic algorithms, parametric equations, NARMA (Non-Linear Auto-Regressive Moving Average) and NARX (Nonlinear autoregressive exogenous model) are also contemplated by the inventors.

It is an object of the invention to predict the structure of a macromolecule having a known primary sequence. Accordingly, a further embodiment comprises selecting a new macromolecule having a known primary sequence and defining an initialized structure for the new macromolecule. The function may then be applied to the known primary sequence and the initialized structure for the new macromolecule to determine the structure of the new macromolecule.

### Computer Implementation

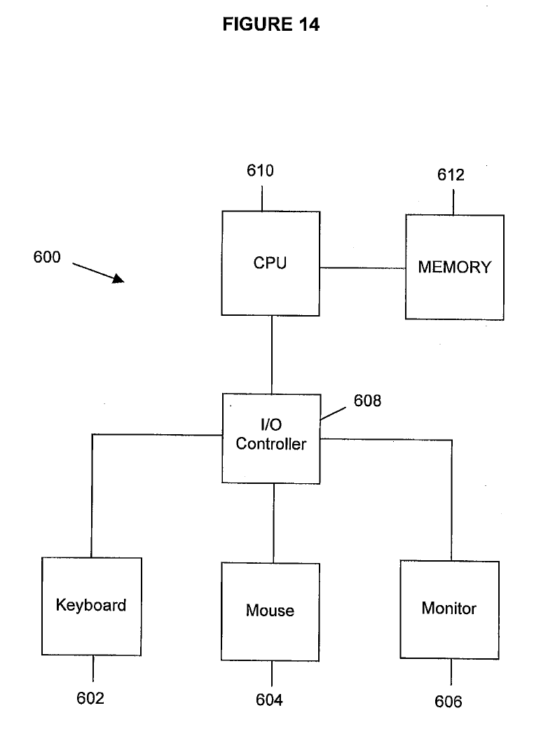

Referring to FIG. 14, there is illustrated in a block diagram, a computer system (600) suitable for implementing an embodiment of the present invention. Specifically, the computer system comprises a processing module such as a CPU (610) connected to a memory (612). The CPU (610) is also connected to an input/output controller (608), which in some embodiments controls access to a keyboard (602), mouse (604) and monitor (606). In some embodiments of the invention, the processing module comprises multiple CPUs.

In accordance with one aspect of the invention, the CPU (610) is configured to implement a preferred embodiment of the invention. In one embodiment, the CPU (610) is configured to perform machine learning wherein a function is provided operable to, for each known macromolecule of a training set, define a corresponding modeled folding path approximating a corresponding projected folding path for the training set. In a further embodiment, the CPU (610) is configured to predict the structure of a macromolecule based on the primary sequence of that macromolecule.

In another aspect of the invention, instructions can be stored on computer readable media and the instructions are operable to configure the processor module to implement the above-described methods.

### Machine Learning System Inputs

The method described by the applicants requires inputs into the function. In one embodiment of the invention, the inputs are vectors that represent salient features taken from macromolecules with known structures that includes either or both (i) spatial relationships describing the atomic structure or conformation of the macromolecule at a given point in time, and (ii) a description of the natural properties (i.e. chemical and/or physical) of the atoms or subunits that make up the macromolecule itself. In one embodiment, the subunits would be the amino acids associated with a given atom. As used herein, a “macromolecular state” refers to information that describes the structure of a macromolecule and may include some description of the natural properties of the atoms or subunits that make up the macromolecule.

The input vector may comprise both a set of relationships describing the atomic structure of the molecule and values describing the natural properties of the macromolecule. In one embodiment, the relationships describing the atomic structure are Relative Spatial Measures (RSMs) that provide a geometric description of the molecule of interest. As used herein, a RSM is defined as a spatial relationship between a number of given points in 3D space that remain constant regardless of the number of translations and/or rotations applied to all the points simultaneously. Examples of RSMs are a torsion angle between four atoms, a bond angle between three atoms, and a bond length between two atoms. As used herein, a “TBL-tuple” or “TBL” refers to the combination of all three RSM types: torsion angle, bond angle, and bond length.

The atoms used to compute a given RSM do not have to be covalently bonded to each other; any atom(s) in the primary sequence can be used depending on the desired information. For example, in determining the spatial description of an atom a with respect to other atoms (in a neighborhood of size n) in terms of bond length, it is possible to compute the bond length of atom a with respect to each and every other atom in the neighborhood; each computed bond length could be used in the input vector. The use of relative spatial representations such as RSM alleviates many computational and learning complexities and significantly reduces computational time while increasing the generality of the approach. Measures defined using a RSM can also be easily converted to Euclidean coordinates with simple mathematical manipulations.

In another embodiment, the input vector also includes data representing the natural properties of the atoms within a given amino acid or other subunit that in some embodiments may comprise the macromolecule. In one embodiment, the subunits are amino acids and the macromolecule is a polypeptide or a protein. A binary encoding of all amino acids can be used, as shown in Example 2; this would require an input dimensionality to 23, while using the embodiment of the natural properties in Example 2 would reduce the input to 14 dimensions. Natural properties could include hydrophobicity, aromaticity, aliphaticity, size, charge, polarity, shape or other characteristics that help the system to disambiguate different types of constituents that comprise the macromolecule. In one embodiment, the constituents consist of atoms or amino acid residues. In other embodiments, the constituents may consist of sugar residues, bases of RNA or DNA. A person skilled in the art would be aware of other categories of natural properties that would be useful for discriminating other groups of linear molecules such as proteins, carbohydrates, RNA or DNA.

The total effect of providing the system with both spatial relationships and natural properties (or other encodings) is that the system can effectively separate the constituents from one another. That is, for a given constituent (identified by its natural properties and its current spatial arrangement with other constituents) the system learns how it should be spatially arranged with respect to other constituents, with respect to time.

In another embodiment, each amino acid in a protein is encoded using a “one-hot” encoding scheme. In this encoding each amino acid is represented by a vector whose dimensionality is equal to the total number of amino acids. For the first amino acid, the first dimension assumes a value of 1, while the rest of the dimensions assume values of 0. The second amino acid, has a pattern of (0,1,0,0, . . . ), and subsequent amino acids follow the same scheme. This provides an unbiased encoding of amino acids.

In a further embodiment, the input vector also includes information on neighborhoods. As used herein “neighborhood” refers to the collective information of a given set of atoms that comprise the macromolecule used to compute an input vector with respect to a reference atom. In one embodiment, the vector includes information on both the 1D-neighborhood and 3D-neighborhood for a reference atom as illustrated in FIG. 7. In FIG. 7, the ‘Reference atom’ is the atom for which the input vector is computed and the 1D-neighborhood consists of contiguous residues on both sides of the reference atom while the 3D-neighborhood is made up of residues nearest to the reference atom in 3D space (possibly excluding the residues of the 1D-neighborhood). The 1D-neighborhood captures the local interactions of neighboring residues with respect to the reference atom, while the 3D-neighborhood captures non-local interactions. The size of the neighborhoods is a parameter that can be set by the user to capture the scope of interactions in the input vector.

### Networks, Plurality of Networks and Outputs

In one embodiment of the invention, a network is used to estimate a function that approximates the folding pathways of a set of macromolecules. In a further embodiment, a plurality of networks are used to estimate a function that approximates the folding paths of a set of macromolecules.

In one embodiment, the network is responsible for learning the dynamics of all three RSMs and a single output vector from the network contains the complete spatial information for a given macromolecule.

In another embodiment the output vector consists of either a torsion angle, a bond angle, or a bond length for a given network amongst an ensemble of networks. That is, an ensemble of networks can be used wherein a given network is trained only for outputting a specific component of a RSM such as a torsion angle, bond angle or bond length.

For a given input vector, a given network could learn any number of outputs. In one embodiment, the network is designed to output vectors containing predictions for the 3 RSMs. Since the target values for all 3 RSMs are known for a given structure in the training set, the discrepancy of each measure with the corresponding target value can be calculated.

The applicants note that allowing separate networks to learn only one component of the RSM for the same set of input vectors decreases that individual network's learning responsibility. In one embodiment, instead of finding a function that maps from a set of input vectors v to a set of output vectors o, where the number elements of o is greater than 1; a function that maps from a set input vectors v to set of output vectors p consisting of one element (i.e. a scalar value) is found. The applicants also note that if multiple networks are used in a machine learning process such as that shown in FIG. 3, the weights have to be adjusted to minimize the discrepancy of all 3 RSMs for the next iteration.

In one embodiment, a network is responsible for learning the dynamics of a protein fold for a single atom type amongst all residues in the backbone and an RSM type. This design constitutes an ensemble of networks. In some embodiments, a network within an ensemble of networks is therefore assigned to learn one type of atom and RSM. Example 5 describes one embodiment of an ensemble of networks wherein one network is assigned to learn one type of atom and RSM. A further embodiment of an ensemble of networks is described in Example 6 for predicting the structure of a protein backbone. In one such embodiment, an atom type could be an amine nitrogen, or a carboxyl carbon of the protein or polypeptide backbone since every residue in the backbone chain contains these atoms in the same order.

In one embodiment, for learning a function that approximates the folding of the side chains, each network is used to learn a specific amino acid side-chain type. This design is similar to that of a single network per amino acid type. In a further embodiment, for learning how the side-chain dynamically folds, an ensemble of networks is used wherein each network is assigned to learn one RSM type for all atoms in a given side-chain for each amino acid type. This design is similar to that of an ensemble of networks per amino acid type.

The applicants note that besides the RSMs and the assignment of learning responsibilities per network mentioned above, a person skilled in the art will appreciate that there are other ways of capturing spatial relationships and assigning learning responsibilities that are within the scope of the invention.

### Neural Networks and Training Procedures

In some embodiments of the invention, the function is implemented by an artificial neural network which learns the necessary relationship between adjacent macromolecule states in the projected folding path. In one embodiment of the invention, a network is trained using a training set of macromolecules for which the primary sequence and its corresponding 3-D structure have already been determined. In one embodiment, the known 3-D structure permits the determination of a suitable RSM for each atom or subunit in a macromolecule.

FIG. 3 represents one embodiment of a training procedure. Referring to FIG. 3, the structures of the molecules in the training set are initialized such that the TBL of each atom is initialized by the corresponding TBL average value, taken over all the training data (100). The applicants note that it is possible to have multiple initial conformations of the same sequence and use these multiple instances as training data. The network can therefore initialize each conformation by using RSM values that have been perturbed around its target RSM. One embodiment of a suitable method that perturbs RSM values is described in Example 8. The advantage of having more training at different conformations is that the system is able to learn more of the folding dynamics of a given family or a set of molecules making it more robust. A person skilled in the art will appreciate other ways of initializing the structures of a given macromolecule. For example, the average of torsion angles could be computed for only amine nitrogen atoms of the backbone and used to initialize only these types of atoms. Next, the network parameters are initialized (101). In one embodiment, the network uses an ensemble of feed-forward neural networks with back-propagation learning, such that the following typical parameters would be set per network: learning rate, momentum rate, the number of input units, the number of hidden layers, the number of hidden units per layer, the number of output units and the connection scheme.

In one embodiment, the order to present the proteins or other macromolecules in the training set to the networks is determined (102). In a further embodiment, protein data is presented to the networks in the same order for repeated iterations (i.e. epochs or passes through a molecule). A specific macromolecule from the training set is then selected to train (103). Next, a suitable input vector is computed for each atom (104). The appropriate network to train based on the atom and RSM type is determined, if multiple networks are being used (105). The network output is then computed (106). The RSM values produced as the output of the network are then compared to the target RSM values of the next step in folding path(s) which is(/are) to be learned. The current RSM is then adjusted toward the target RSM associated with the input atom for the corresponding network (107). Note that the adjustment is performed on a copy of the RSM and the original copy will be updated after all atoms in the molecule have been visited and their RSMs adjusted (111). The RSM discrepancy (error) of the network output to that of the corresponding target RSM is computed (108). Example 7 provides one embodiment of a suitable method of adjusting the current RSM towards the target RSM and calculating the discrepancy between the network output and target RSM. In one embodiment, the cumulative error for each network is recorded; such errors can then be used as a condition to exit training (114). The network weights based on the RSM discrepancy are also adjusted (109).

Still referring to FIG. 3, the system then verifies if there are any more atoms in the protein chain to adjust (110). If all atoms have been visited for this pass, the original RSMs are updated (111) and these new RSMs are used to compute the new 3D coordinates (112); otherwise, the next atom in the molecule proceeds through steps (104) to (110). The system checks whether there are any remaining molecules in the training set to be trained for this pass (113). If all training molecules have been adjusted through the training process, the accumulated error for each network is tested to see if it satisfies the exit condition (114). If the errors for all networks satisfy the exit condition, training is stopped (115) and the system may proceed to the testing phase (116); otherwise, the system continues training at box (102).

In one embodiment, for each macromolecule in the training set, a projected folding path comprising a progression of state-specific projected structures for a macromolecular from the initialized structure to the known structure is defined. The input vectors comprise RSM data for a given atom or subunit for a specific state-specific projected structure in the projected folding path. The output of the network comprises modeled RSM data, wherein the function defined by the modeled folded path approximates the projected folding path.

In another embodiment of the invention, the known structures of the macromolecules are used for training the network. The input vectors comprise RSM data for a given atom or subunit for a specific state-specific projected structure in the correctly folded molecule. The output of the network comprises modeled RSM data, wherein the function defined by the incremental change represents no change.

### Structure Prediction

In some embodiments of the invention, the function is applied to the primary sequence of a new or unknown macromolecule using a trained network. Once a network has been trained, the network may be used for structure prediction of a new unknown macromolecule.

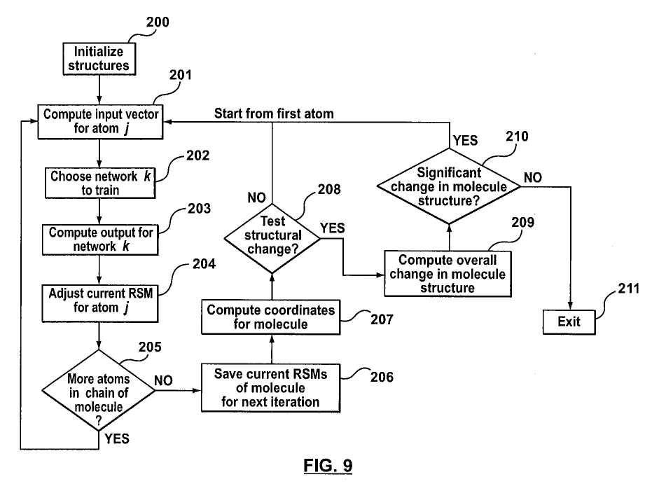

FIG. 9 represents one embodiment of a testing procedure for predicting the structure of an unknown macromolecule. Referring to FIG. 9, the unknown structure is first initialized (200) to some conformation. In one embodiment, the structure is initialized by setting the TBL of each atom in the chain using the corresponding TBL average value computed from the training procedure (see FIG. 3 (100)). Thereafter, the input vector for the atom visited is computed (201). Next, the appropriate network to do the prediction is selected (202) based on the reference atom type and the RSM output type. The output for the chosen network is then computed (203) and this value is used to adjust a copy version of the RSM (204). Notice that adjustment of the current RSM is based on what the system learned during training, while during the training procedure (i.e. FIG. 3 (107)) adjustment of the current RSM is directed towards the known target RSM value (204). The system checks if there are any atoms not yet adjusted for this pass (205). If all the atoms in the molecule to be tested have been visited for this pass, the original RSMs are updated (206) and these new RSMs are used to compute the new 3D coordinates (207). The system then checks after a certain number of passes through the protein, whether significant overall structural change has occurred (208). In one embodiment, a simple and computationally efficient solution to testing overall structural change is to use the first three atoms of a protein backbone (i.e. nitrogen, alpha carbon, and carboxyl carbon) and compute the torsion angle, bond angle, and bond length with respect to the last alpha carbon in the chain. Significant changes of corresponding RSM from pass x to pass y, where x<<y, would indicate that the prediction has not converged and hence further adjustments are needed. The number of passes before testing depends on the rate of adjustment of RSM. For example, in one embodiment if the rate of adjustment for a bond angle is 0.001, then approximately 1000 passes will recover what is adjusted from the first pass to the last pass. If convergence has been attained by the system, in one embodiment the system will test for overall structural change every 1500 passes and still see very little overall change. On the other hand, if the prediction has not converged, the probability of seeing significant change every 150 passes would be fairly high. Returning to (208), if the changes are significant, the system continues to adjust the protein (201); otherwise, the system exits (211) since the structure has converged to a stable conformation.

The system may then display, record or export the predicted structure for the macromolecule.

### EXAMPLES

### Example 1

### Relative Spatial Measures

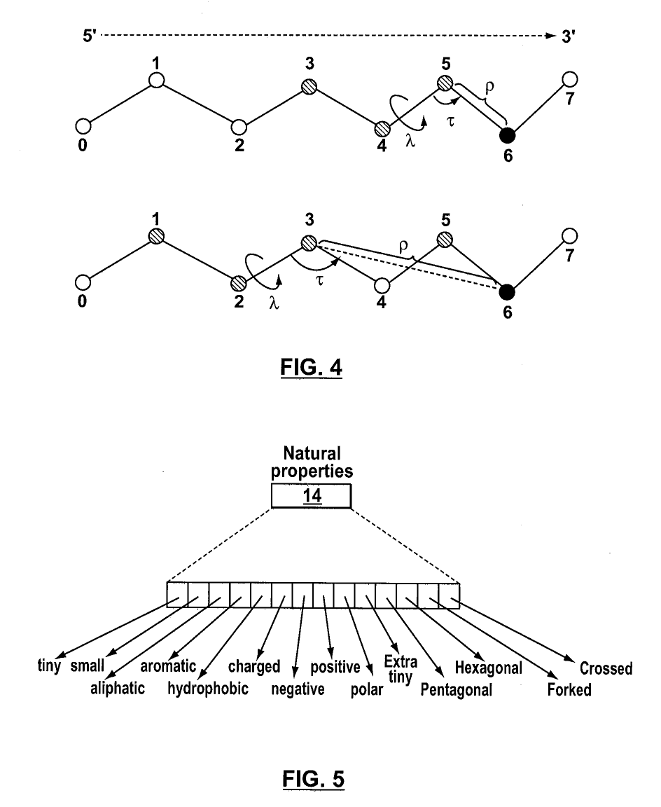

FIG. 4 shows one example of Relative Spatial Measures (RSMs) for a macromolecular primary structure consisting of 8 atoms. The RSMs of each atom is a measure of the torsion angle, bond angle, and bond length of the atom in question with respect to a group of three contiguous atoms of the chain from the 5′ to 3′ direction. For example, the RSMs of atom 6 are computed with respect to the group of three atoms labeled as 3, 4, and 5 as shown in FIG. 4 (top diagram). The torsion angle (λ) is computed using atoms 3, 4, 5, and 6; the bond angle (τ) is computed using atoms 4, 5, and 6; and the bond length (ρ) is computed using atoms 5 and 6. The RSMs of an atom can also be computed with respect to groups of non-adjacent atoms. The RSMs of atom 6 can also be computed with respect to groups of non-adjacent atoms. In FIG. 4 (bottom diagram), the RSMs of atom 6 are computed using atoms 1, 2, and 3 instead of atoms 3, 4, and 5.

### Example 2

### Natural Property Identifiers

FIG. 5 shows an example of 14-bit encoding used to identify an amino acid for a given atom. Each bit describes a certain physical-chemical property of a particular residue; a ‘1’ would indicate the presence of the property, ‘0’ otherwise. The 23 possible residue types as commonly used in the Protein Data Bank form are listed in Table 1.

TABLE 1
Amino acid codes

| Full amino acid name | Three-letter code | Single-letter code |
|---|---|---|
| Alanine | ALA | A |
| Arginine | ARG | R |
| Asparagine | ASN | N |
| Aspartic acid | ASP | D |
| ASP/ASN ambiguous | ASX | B |
| Cysteine | CYS | C |
| Glutamine | GLN | Q |
| Glutamic acid | GLU | E |
| GLU/GLN | GLX | Z |
| ambiguous | | |
| Glycine | GLY | G |
| Histidine | HIS | H |
| Isoleucine | ILE | I |
| Leucine | LEU | L |
| Lysine | LYS | K |
| Methionine | MET | M |
| Phenylalanine | PHE | F |
| Proline | PRO | P |
| Serine | SER | S |
| Threonine | THR | T |
| Tryptophan | TRP | W |
| Tyrosine | TYR | Y |
| Unknown | UNK | X |
| Valine | VAL | V |

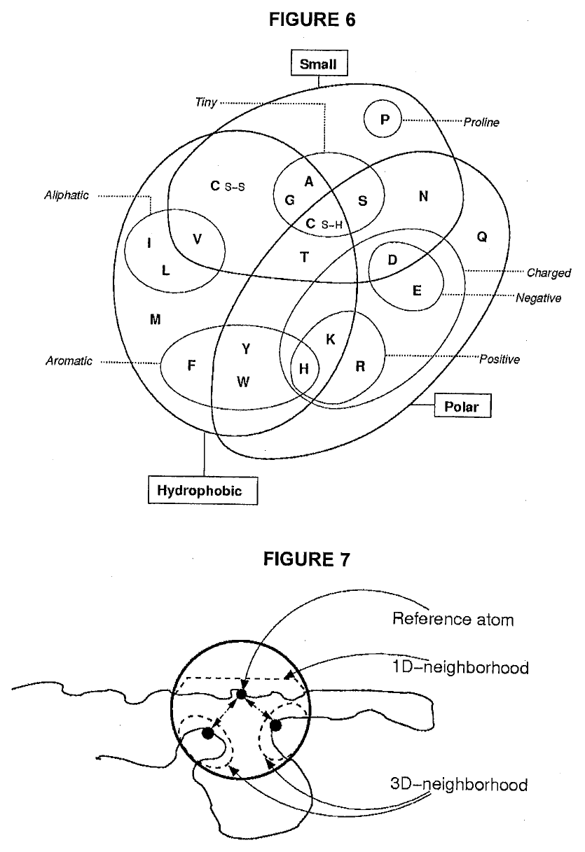

All the amino acids in Table 1, with the exception of the ambiguous ones (namely, B, Z, X) can be categorized into their respective 8 natural properties according to FIG. 6 (Taken from http://www.rcsb.org/pdb/).

The last five categories (‘extra tiny’, ‘pentagonal’, ‘hexagonal’, ‘forked’, ‘crossed’) are additional features that were included to disambiguate between properties shared by more than one residue (i.e., A and G for the Tiny property), and to provide extra information about the geometry of the atomic arrangements for a particular residue. These categories are:
Tiny with corresponding amino acids A, G, C, and S.
Small with corresponding amino acids A, G, C, S, P, T, N, D, and V.
Aromatic with corresponding amino acids F, W, Y, and H.
Aliphatic with corresponding amino acids I, L, and V.
Charged with corresponding amino acids D, E, K, R, and H.
Negative with corresponding amino acids D and E.
Positive with corresponding amino acids K, R, and H.
Polar with corresponding amino acids D, E, K, R, H, W, Y, T, C, S, N, and Q.
Hydrophobic with corresponding amino acids F, W, Y, H, K, T, C, A, G, V, I, L, and M.
Extra tiny with corresponding amino acids G.
Pentagonal with corresponding amino acids W, P, and H.
Hexagonal with corresponding amino acids F, W, and Y.
Forked with corresponding amino acids R, N, D, Q, E, L, and V.
Crossed with corresponding amino acids I, S, and T.

With the exception of the ambiguous residues (B, Z, and X) in Table 1, the above encoding can uniquely identify all amino acids by using 14 bits. However, depending on the available information of a given residue, an ambiguous residue may be identifiable. For example, if a residue is determined to be ASX, and we know it to be small, charged, polar, and forked, then we know it to be ASP, even though information about its negativity is missing. There are three benefits to this encoding: (i) the number of dimensions in the feature space are fewer than if we were to use an orthogonal encoding for each amino acid (i.e., 14 versus 23), (ii) ambiguous cases can have a higher chance of being correctly classified due to the additional five categories, and (iii) the encoding conveys relevant information.

### Example 3

### Sample Input Vector

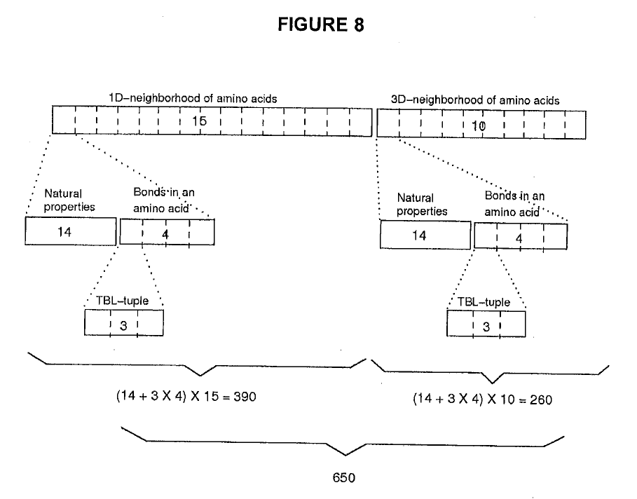

FIG. 8 provides an example of an input vector for predicting a peptide backbone (i.e. nitrogen, alpha carbon, and carboxyl carbon) and oxygen off the carboxyl per residue, and is made up of a 1 D-neighborhood of size fifteen residues and a 3D-neighborhood of size ten. In FIG. 8, each slot of the ‘1 D-neighborhood of amino acids’ represents the natural properties (14 bits) of a given atom within an amino acid and the TBL computed with respect to a group of contiguous atoms g that is adjacent and previous to a reference atom r for a chain from the 5′ to 3′ direction. Since for this example each neighbour is a residue dᵢ consisting of four atoms f, it is enough to use one 14-bit vector of natural properties n to disambiguate dᵢ from another residue dⱼ, where i≠j, and concatenate the four TBLs representing each atom of f to n. Because the 1D-neighborhood size is 15, the total dimensionality from this neighborhood is 390. For the 3D-neighborhood, we determine 10 residues that are closest to the reference atom r, but not in the 1D-neighborhood, and follow the same computations described above for each of the 10 residues. The total dimensionality for the 3D-neighborhood is 260. Hence, adding the dimensionalities of the two neighborhoods, there is a total of 650 dimensions for the input vector.

### Example 4

### Conserved Structure Input Encoding

It is well known that the relationship between local sequence and structure are not strictly unique, resulting in an N to 1 mapping. That is, more than one local sequence can assume a given tertiary structure. In the context of our approach, input encoding for amino acids that is orthogonal or widely dispersed in hyperspace requires training a significant number of proteins to compensate for the sequence variation. Accordingly, another embodiment for input encoding is described as follows. The first step is to build a library of non-redundant structures of size n amino acids. People skilled in the art will choose n according to the specific needs of the method macromolecules. In some embodiments a window of size 4-8 amino acids has been found to provide good results. A library of n-residue fragments is obtained by sliding a window of size n over the chain for each protein from the protein training set and clustering the fragments using similarity metrics such as root mean square deviation (RMSD) (See for example, S. Kearsley. On the orthogonal transformation used for structural comparisons. Acta Cryst., 45:208-210, 1989), torsion angles (See for example, D. Hoffman. Comparison of protein structures by transformation into dihedral angle sequences. PhD thesis, Department of Computer Science, University of North Carolina, Chapel Hill, 1996), and distance matrices and distance map (See for example, L. Holm and C. Sander. Protein structure comparison by alignment of distance matrices. Journal of Molecular Biology, 233:123-138, 1993). The goal is to build a library that covers as much as possible the sequence variations that map onto the more conserved structures.

The second step is to join all the clusters together and align all fragments into their respective columns. The result will be an alignment of n columns. Notice that the alignment is not based on any scoring function. Thereafter, the relative frequency of amino acid j at aligned column i, with Σⱼ₋₁²⁰F(i,j)=1 for a given column i is computed. Hence, a given column i is represented by a 20×1 amino acid profile row vector P_{aminoacid}. In one embodiment, P_{aminoacid} in converted into a property profile P_{property} as follows (See for example, O. Sander. Local sequence-structure relationships in proteins. PhD thesis, Department Informatik, University of Erlangen-Nuremberg, Germany, 2004):

P_{property}=(Mₐₐ_{_{—}}ₚᵣₒₚₑᵣₜᵢₑₛ·P^{T}_{aminoacid})

The entries in matrix Mₐₐ_{_{—}}ₚᵣₒₚₑᵣₜᵢₑₛ are theoretically derived properties associated with each amino acid. One example of Mₐₐ_{_{—}}ₚᵣₒₚₑᵣₜᵢₑₛ based on the amino acid properties described in Example 2, is provided in Table 2. Other embodiments of Mₐₐ_{_{—}}ₚᵣₒₚₑᵣₜᵢₑₛ are also possible.

TABLE 2

| Property | A | R | N | D | C | Q | E | G | H | I | L | K | M | F | P | S | T | W | Y | V |
|---|---|---|---|---|---|---|---|---|---|---|---|---|---|---|---|---|---|---|---|---|
| Tiny | 1 | 0 | 0 | 0 | 0 | 0 | 0 | 1 | 0 | 0 | 0 | 0 | 0 | 0 | 0 | 1 | 0 | 0 | 0 | 0 |
| Small | 1 | 0 | 1 | 1 | 1 | 0 | 0 | 1 | 0 | 0 | 0 | 0 | 0 | 0 | 1 | 1 | 1 | 0 | 0 | 1 |
| Aromatic | 0 | 0 | 0 | 0 | 0 | 0 | 0 | 0 | 1 | 0 | 0 | 0 | 0 | 1 | 0 | 0 | 0 | 1 | 1 | 0 |
| Aliphatic | 0 | 0 | 0 | 0 | 0 | 0 | 0 | 0 | 0 | 1 | 1 | 0 | 0 | 0 | 0 | 0 | 0 | 0 | 0 | 1 |
| Charged | 0 | 1 | 0 | 1 | 0 | 1 | 0 | 0 | 1 | 0 | 0 | 1 | 0 | 0 | 0 | 0 | 0 | 0 | 0 | 0 |
| Negative | 0 | 0 | 0 | 1 | 0 | 1 | 0 | 0 | 0 | 0 | 0 | 0 | 0 | 0 | 0 | 0 | 0 | 0 | 0 | 0 |
| Positive | 0 | 1 | 0 | 0 | 0 | 0 | 0 | 0 | 1 | 0 | 0 | 1 | 0 | 0 | 0 | 0 | 0 | 0 | 0 | 0 |
| Polar | 0 | 1 | 1 | 1 | 0 | 1 | 1 | 0 | 1 | 0 | 0 | 1 | 0 | 0 | 0 | 1 | 1 | 1 | 1 | 0 |
| Hydrophobic | 1 | 0 | 0 | 0 | 1 | 0 | 0 | 1 | 1 | 1 | 1 | 1 | 1 | 1 | 0 | 0 | 1 | 1 | 1 | 1 |
| Extra tiny | 0 | 0 | 0 | 0 | 0 | 0 | 0 | 1 | 0 | 0 | 0 | 0 | 0 | 0 | 0 | 0 | 0 | 0 | 0 | 0 |
| Pentagonal | 0 | 0 | 0 | 0 | 0 | 0 | 0 | 0 | 1 | 0 | 0 | 0 | 0 | 0 | 1 | 0 | 0 | 1 | 0 | 0 |
| Hexagonal | 0 | 0 | 0 | 0 | 0 | 0 | 0 | 0 | 0 | 0 | 0 | 0 | 0 | 1 | 0 | 0 | 0 | 1 | 1 | 0 |
| Forked | 0 | 1 | 1 | 1 | 0 | 1 | 1 | 0 | 0 | 0 | 1 | 0 | 0 | 0 | 0 | 0 | 0 | 0 | 0 | 1 |
| Cross | 0 | 0 | 0 | 0 | 0 | 0 | 0 | 0 | 0 | 1 | 0 | 0 | 0 | 0 | 0 | 1 | 1 | 0 | 0 | 0 |

This results in n vectors of P_{property}, one for each corresponding column i, such that the encoding for the molecule chain can be computed. First, each amino acid is encoded according to Mₐₐₚᵣₒₚₑᵣₜᵢₑₛ. Then, during training or testing, as a window (or neighborhood) of size n is moved over the chain, the encoding Mₐₐ_{_{—}}ₚᵣₒₚₑᵣₜᵢₑₛ for the n amino acids are subtracted vector-wise from P_{property}. The idea is that the amino acid fragment, transformed into their corresponding P_{property}, will have a similar pattern if they possess similar structure. This can be more easily seen if the amino acid profile is computed for each cluster before they are joined to calculate P_{property}.

### Example 5

### The Use of Ensembles of Networks or a Single Network

This Example presents an embodiment of the operation of an ensemble of networks. In one such embodiment, network a is assigned to learn the torsion angles of the set n of all amine nitrogen atoms of the backbone for a given molecule m. For network a and for reference amine nitrogen r belonging to the set n, an input vector would be computed and applied to network a, and a corresponding torsion angle t would be computed by network a as its output. Network a would then compare t with the known torsion angle k for r, and based on the discrepancy would adjust the weights so that the next time the torsion angle for r is computed, it would be towards the target torsion angle k. Network b could then be assigned to learn the bond angles of the same set n of all amine nitrogen atoms of the backbone for the same molecule m. Here, the same input vector computed in network a is used in network b for reference amine nitrogen r. The only difference now is that the output to network b is a bond angle instead of a torsion angle, and network b uses the bond angle target value to adjust its weights instead of the torsion angle target value used by network a. If network c is responsible for learning the bond length of all carboxyl carbon atoms in the backbone for molecule m, it computes an input vector for each carboxyl carbon along the chain and produces as output a bond length. Network c would then use the corresponding bond length target to adjust its weights. Note that the set of input vectors computed by network a and network b are the same, while it is different for network c, in a given pass.

FIG. 10 illustrates the relationship between an input vector and an output vector for the ensemble of multiple networks described above. Referring to FIG. 10, the dotted box shows a short hypothetical macromolecule chain running from the 5′ to 3′ direction. Here, we are interested in computing the RSM for the reference atom r (atom 5; see ‘output’ in FIG. 10) with respect to the three atoms g (atoms 2, 3, 4 line-filled in FIG. 10). The network will produce as output an RSM that describes the spatial arrangement of r with respect to g at time t. To compute the input vector for r for a given neighborhood (for this example the neighborhood is the entire chain), the TBL for each atom p (black-filled) with respect to the group g is computed. The TBL computed for each atom p for an amino acid d in the sequence is then concatenated with the natural properties representing d. That is, only a single natural properties vector is required for any atoms pᵢ and pⱼ in the same residue, where i≠j (see FIG. 8). For the atoms in g, its TBL computed from a previous pass is used, which were network outputs (these outputs are from different networks assigned with different learning responsibilities as described above). For example, the RSM computed for the reference atom r for this pass would be used in the next pass as an element of the TBL if r happens to be an atom in group g. After the input vector for r is computed and applied to the network, the RSM computed provides a spatial description of r with respect to the group g.

If a single network is used to learn all the RSM values of all atoms in the backbone and the oxygen bonded to the carboxyl group, the input vectors consists of the set of all input vectors from all the ensemble networks in the embodiment described above. The only difference here is that for each reference atom r, the output vector consists of all three RSM measures, instead of one RSM type. To adjust the network weights, the corresponding target RSM measures for r are used to compute the discrepancies with respect to the outputs.

### Example 6

### An Ensemble of Networks for Predicting the Structure of a Protein Backbone

One example of an ensemble of Networks for the prediction of protein structure is as follows:
Network 1: Computes the torsion angle of all Nitrogen Atoms in the backbone.
Network 2: Computes the bond angle of all Nitrogen Atoms in the backbone.
Network 3: Computes the bond length of all Nitrogen Atoms in the backbone.
Network 4: Computes the torsion angle of all Alpha Carbon Atoms in the backbone.
Network 5: Computes the bond angle of all Alpha Carbon Atoms in the backbone.
Network 6: Computes the bond length of all Alpha Carbon Atoms in the backbone.
Network 7: Computes the torsion angle of all Carboxyl Carbon Atoms in the backbone.
Network 8: Computes the bond angle of all Carboxyl Carbon Atoms in the backbone.
Network 9: Computes the bond length of all Carboxyl Carbon Atoms in the backbone.
Network 10: Computes the torsion angle of all the Oxygen Atoms bonded to the Carboxyl Carbon Atoms.
Network 11: Computes the bond angle of all the Oxygen Atoms bonded to the Carboxyl Carbon Atoms.
Network 12: Computes the bond length of all the Oxygen Atoms bonded to the Carboxyl Carbon Atoms.

### Example 7

### Adjustment of RSM towards Target RSM and Calculation of the RSM Discrepancy.

In one embodiment, the current RSM is adjusted toward the target RSM associated with the input atom for the corresponding network as shown in FIG. 3 (107). Note that the adjustment is performed on a copy of the RSM and the original copy will be updated after all atoms in the molecule have been visited and their RSMs adjusted (see FIG. 3 (111)). In one embodiment, the adjustment of the RSMs are done as follows:

NEW_{—}RSM=CURRENT_{—}RSM+((NETWORK_{—}OUTPUT *2.0*UBOUND)−UBOUND)*DELTA (1)

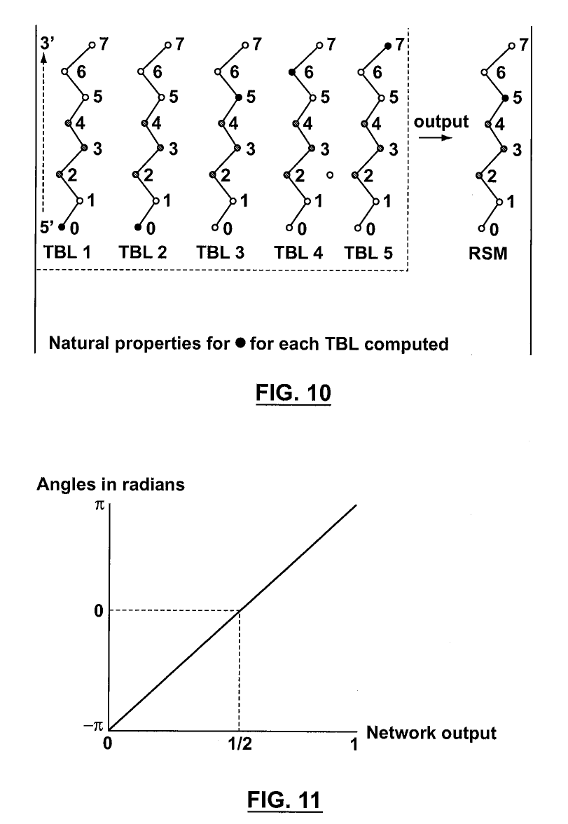

In Equation (1), NEW_RSM is the updated RSM after adjustment; CURRENT_RSM is the current RSM; NETWORK_OUTPUT is the network output and is between 0 and 1, inclusive; and DELTA is the adjustment rate. UNBOUND depends on the type of RSM. For the torsion and bond angle, UBOUND is PI (3.14159265), which is the highest real number angle. For the bond length, it would be the longest bond length observed in the training data. FIG. 11 provides an illustration of the example for torsion and bond angles and helps to clarify the term ((NETWORK_OUTPUT *2.0*UBOUND)−UBOUND) in Equation (1).

In one embodiment, the RSM discrepancy (error) of the network output to that of the corresponding target RSM is computed as show in FIG. 3 (108). In one embodiment, the computations for this task are:

OLD_{—}DIFF=TARGET_{—}RSM−CURRENT_{—}RSM (2)

NEW_{—}DIFF=NETWORK_{—}OUTPUT*2.0*UBOUND−UBOUND (3)

DIFF_{—}SQ=(OLD_{—}DIFF−NEW_{—}DIFF)*(OLD_{—}DIFF−NEW_{—}DIFF) (4)

In Equation (2), OLD_DIFF is just the difference between the target RSM and the current RSM (i.e. the original copy). In Equation (3), NEW_DIFF is the prediction made by the network based on the current molecule conformation (i.e. the original copies of RSMs for the molecule). NETWORK_OUTPUT and UBOUND in (3) are the same as in Equation (1). In Equation (4), the difference of OLD_DIFF and NEW_DIFF is squared, giving the discrepancy for a given RSM computation associated with an atom.

### Example 8

### Learning and Predicting With More Folding Pathways

When using dynamical function approximation, predictions tending toward a given response function's attractors can be increased by exposing the learning system to more training exemplars that results in the “widening” of the areas around the basins of attraction. A training and testing strategy that achieves the effects just described may make use of the procedures illustrated in FIGS. 3 and 9.

In one embodiment, a training strategy starts off by training N sessions of the training procedure described in FIG. 3, where N>1. For each training session j out of a total of N training sessions, n structures for each sequence i in the training set A^{p-} are permuted; the union of all the permuted structures results in a new set A^{p+,j} used for training session j. Formulations for A^{p-} and A^{p+,j} are:

$$\begin{matrix}{A}^{p -} = \{ {a}_{i}^{p -} ⊆ U \} \\ and & ( 5 ) \\ {A}^{p + , j} = \{ {a}_{i}^{p -} ∈ {A}^{p -} \vert {⋃}_{0 \leq k < n} ( {P}_{1} ( {a}_{i}^{p -} ) -> {a}_{i , k}^{p + , j} ) \} & ( 6 )\end{matrix}$$

In Equation (5), U is the set of all proteins with known structures; aᵢ^{p-} denotes a non-permuted protein i selected as a training protein; and the superscript p− indicate that the TBLs for the proteins in A^{p-} are not permuted.

In Equation (6), a non-permuted protein aᵢ^{p-}∈A^{p-} is applied to a permutation function P₁ that initializes the TBLs of aᵢ^{p-}, resulting in a permuted protein a_{i,k}^{p+,j} being produced for training session j, where 0≦k<n. The union of all a_{i,k}^{p+,j} permuted proteins forms A^{p+,j}. The superscript p+in Equation (6) denotes that the TBLs for the proteins in A^{p+,j} are permuted (i.e. randomized).

Strategies for permuting the training structures and the initialization of architecture parameters for the training sessions can be the same or different. Notice that this method is conducive to code parallelization because training sessions are executed independent of each other.

After training all N sessions, the set of weights W={w_{Ap+,j},0≦j<N} can be used to predict a set B^{p-} of unseen sequences:

B^{p+}={bᵢ^{p-}⊂V̂bᵢ^{p-}∉A^{p-}I∪(P_{w}(bᵢ^{p-})→bᵢ^{p+})} (7)

In Equation (7), bᵢ^{p-} is just the primary structure (i.e. linear sequence) from the set of all proteins V, where U⊂V. The permutation function P₂ is similar to P₁ in Equation (6) and is used to initialize the TBLs of bᵢ^{p-}, giving us bᵢ^{p+}.

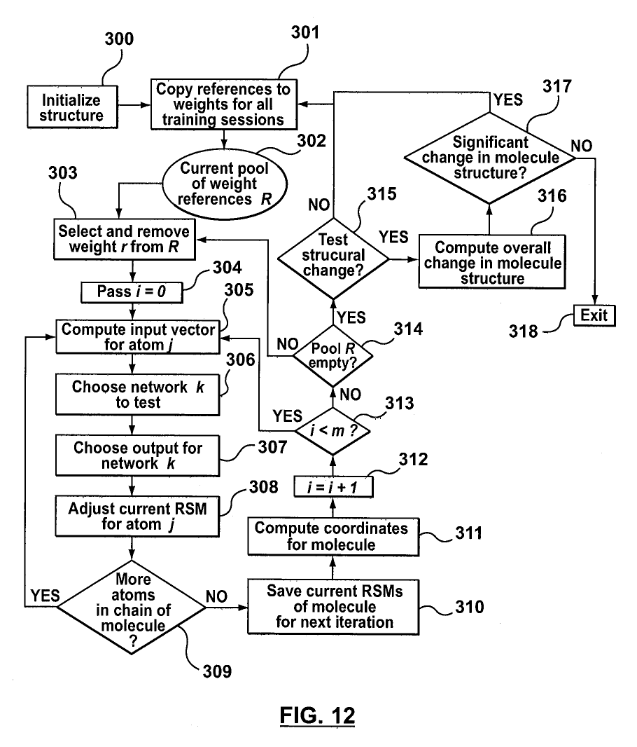

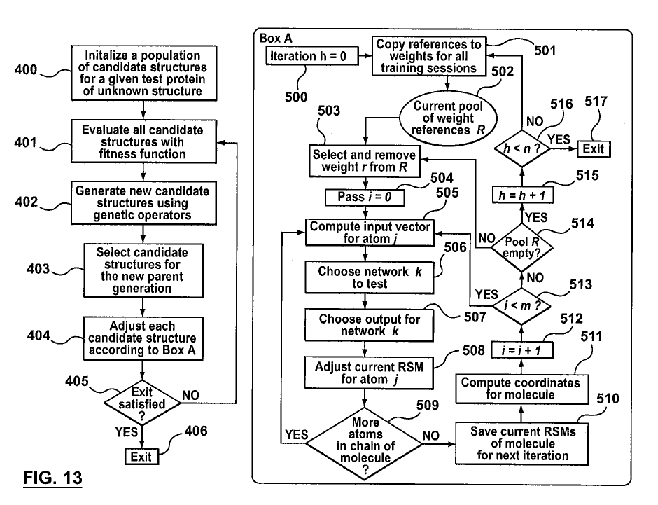

FIG. 12 shows how a given unseen sequence bᵢ^{p+}∈B^{p+} is predicted using all the training session weights W. Referring to FIG. 12, in (300), B^{p+} is generated as described in Equation (7). Next, all references are copied to W (301) and placed in a current working pool R since W does not get changed during the prediction procedure (302). Next, a reference weight r∈R is selected and removed (303) and is used to adjust the TBLs of bᵢ^{p+} for m passes. In (304) the number of passes is initialized to 0. Next, the input vector for atom j is computed (305) as in FIG. 9 (201). The network k is chosen corresponding to the atom type for atom j to perform the prediction (306) as in FIG. 9 (202). Recall that each reference weight r refers to complete set of weights (see the definition for W). The network output for network k is the computed (307) as in FIG. 9 (203). In (308), the current RSM for atom j is adjusted as in FIG. 9 (204). In (309), it is determined whether there are more atoms in bᵢ^{p+} whose TBLs need to be adjusted as in FIG. 9 (205). If there are more atoms, the procedure returns to (305), otherwise the current RSMs for the next pass are saved (310) and the coordinates for bᵢ^{p+} are computed (311), as in FIG. 9 (206) and (207), respectively. Next, the counter for the number of passes made through bᵢ^{p+} wherein reference weight r was used to perform the prediction is updated (312). In (313) the system evaluates whether if m passes have been made using r. If fewer than m passes were made, the system returns to (305) and starts adjusting bᵢ^{p+} from the first atom again. Otherwise, the system proceeds to (314) wherein it is determined if all weight references have been used (i.e. R=Ø). If R=Ø, the system continues through (315) to (318). Otherwise, the system selects another reference weight r∈R to adjust bᵢ^{p+} and returns to (303).

Note that (301) signals the start of a cycle, while the beginning of (315) signals the end of the same cycle. Also, in (303) any number of strategies can be used to select the reference weight r. For example, it could be kept the same per cycle, or randomly selected per cycle.

### Example 9

### Predicting with Environmental Information

A major weakness with fragment-based ab-initio prediction methodologies is that the number of “states” in torsion angle space that they can tractably sample during rigid fragment assembly are limited to fewer than 20 for a protein of length 100 amino acids or fewer. However, the recent successes of fragment-based ab-initio modeling for predicting novel folds reveals that the approach still have good merits. Accordingly, an embodiment of our system combines the benefits of learning folding pathways with the concept of exploring the conformation space of protein structures. Since the present invention models how proteins fold as function by iteratively adjusting and learning how the process is done, the number of “states” that our system can predict is theoretically only limited by the number of folds it is exposed to. That is, embodiments of the invention can predict either the original fold that it trained, or the folds not present in known structures by “blending” the knowledge of multiple folds learned. Combining learning with the ability to explore the space of conformations and validation through energy minimization would greatly reduce the likelihood of embodiments of the invention being “stuck” in a local minimum.

FIG. 13 shows an embodiment of invention that wraps a Genetic Algorithm (GA) around the testing procedure as shown in FIG. 12 in order to utilize the more admirable feature of the ab-initio approach.

Referring to FIG. 13, a population of candidate structures for a given test protein are generated and initialized (400) (i.e. bᵢ^{p+}∈B^{p+} in Equation (7)). Next, the system evaluates all the candidate structures using a fitness function that measures the fitness level of each candidate structure (401). The fitness function can be a single variable such as the force mechanic potential energy of bᵢ^{p+}'s current conformation, or a vector of values representing bᵢ^{p+}'s current conformation (i.e. torsion energy, van der Waals energy, etc.). Regardless of the form taken by the fitness function, the system seeks to optimize this function. The system then generates new candidate structures using genetic operators to explore the space of possible conformations (402). Next, the system selects the candidate structures that show promise in terms of their fitness value and allows them to survive to the next generation or iteration (403). In (404), each candidate structure is adjusted using the algorithm listed in Box A. Notice that unlike fragment-based ab-initio modeling that is limited by the number of states they can adjust, the present system utilizes all the knowledge stored in the weights from all the training sessions, thus making predictions of much larger proteins feasible. In (405), the system evaluates whether the exit condition has been satisfied. If the condition is not satisfied, the system returns to (401); otherwise it exits. A possible exit condition is whether the population as a whole shows significant structural changes. If a single-objective fitness function is optimized, then most candidate structures should converge to similar structures. On the other hand, if a multi-objective fitness function is optimized, then a Pareto distribution in the candidate structures should result. Other embodiments are also possible.

Note that Box A in FIG. 13 is very similar to the embodiment illustrated in FIG. 12. In FIG. 12, the exit condition was based on whether the predicted model showed significant structural changes after a certain number of cycles. However, in Box A of FIG. 13 the system continues to adjust bᵢ^{p+} until n cycles is reached (516). Other variations and modifications of the invention are possible. All such modifications or variations are believed to be within the sphere and scope of the invention as defined by the claims appended hereto.

1. A method for modeling the structure of a macromolecule based on the primary sequence of that macromolecule, the method comprising:
a) selecting a training set of known macromolecules, wherein each known macromolecule of the training set has a known structure and a known primary sequence;
b) defining an initialized structure for each known macromolecule of the training set based on its primary sequence;
c) for each known macromolecule of the training set, defining a corresponding projected folding path comprising a progression of n projected macromolecule states, beginning with the initialized structure and ending with the known structure, wherein n is a positive integer greater than 2, wherein each macromolecule state in the n macromolecule states has a corresponding primary sequence, and a state-specific projected structure;
d) providing a function operable to, for each known macromolecule of the training set, define a corresponding modeled folding path approximating the corresponding projected folding path, wherein
i) the corresponding modeled folding path comprises a progression of n modeled macromolecule states, beginning from the initialized structure and ending with the known structure,
ii) each modeled macromolecule state in the n macromolecule states has the primary sequence and a state-specific modeled structure, and
iii) the function is operable to, for each modeled macromolecule state progression of n modeled macromolecule states except the last modeled macromolecule state, translate the state-specific structure of any macromolecule state in the corresponding folding path into the state-specific structure of the immediately following macromolecule state in the progression.

2. The method as defined in claim 1 further comprising
e) selecting a new macromolecule having a known primary sequence and defining an initialized structure for the new macromolecule; and,
f) applying the function to the known primary sequence and the initialized structure for the new macromolecule to predict the structure of the new macromolecule.

3. The method as defined in claim 1, wherein d) is performed using machine learning.

4. The method as defined in claim 3, wherein machine learning is conducted using a support vector machine.

5. The method as defined in claim 3, wherein machine learning is conducted using a neural network.

6. The method as defined in claim 3, wherein machine learning is conducted using a plurality of neural networks.

7. The method as defined in claim 1, wherein in step c) the projected folding path for a known macromolecule is defined using a linear interpolation between the initialized structure and the known structure to generate the n projected macromolecule states.

8. The method as defined in claim 2 further comprising:
for each known macromolecule of the training set, deriving a plurality of input vectors from the corresponding initialized structure and the primary sequence, and a plurality of target vectors from the macromolecule states of the projected folding path; wherein,
in d), the function is operable to, for each modeled macromolecule state progression of n modeled macromolecule states except the last modeled macromolecule state, translate the state-specific structure of any macromolecule state in a corresponding folding path into the state-specific structure of the immediately following macromolecule state in the progression by determining a corresponding plurality of input vectors defining the immediately following macromolecule state based on a preceding plurality of input vectors for the preceding macromolecule state.

9. The method as defined in claim 8 further comprising:
for each new macromolecule, deriving a plurality of input vectors from the corresponding initialized structure and the primary sequence of the new macromolecule; and
in f), applying the function to the known primary sequence and the initialized structure for the new macromolecule comprises applying the function to the plurality of input vectors derived from the corresponding initialized structure and the primary sequence of the macromolecule.

10. The method as defined in claim 9, wherein:
for each known macromolecule in the training set, the corresponding known primary sequence in resoluble into a plurality of subunits; and
b) comprises for each known macromolecule in the training set, deriving an input vector for each subunit in the plurality of subunits in the corresponding known primary sequence and the initialized structure to provide the plurality of input vectors.

11. The method of claim 10 wherein the plurality of subunits are a plurality of amino acids, carbohydrate residues or nucleic acids.

12. The method as defined in claim 10 wherein the plurality of subunits are a plurality of atoms.

13. The method as defined in claim 12 wherein the input vector for each atom comprises a plurality of relative spatial measures of that atom relative to other atoms in the corresponding known macromolecule primary sequence.

14. The method as defined in claim 13 wherein the plurality of relative spatial measures comprises at least one of i) a torsion angle between the atom and a plurality of other atoms in the macromolecule primary sequence; ii) a bond angle between the atom and two other atoms in the macromolecule primary sequence; and, iii) a bond length between the atom and another atom in the primary sequence.

15. The method as defined in claim 11 wherein the wherein the input vector for each subunit comprises a plurality of relative spatial measures of that subunit relative to other subunits in the corresponding known macromolecule primary sequence.

16. The method as defined in claim 15 wherein the plurality of relative spatial measures comprises at least one of i) an angle between the subunit and a plurality of other subunits in the macromolecule primary sequence; ii) an angle between the subunit and two other subunits in the macromolecule primary sequence; and, iii) a distance between the subunit and another subunit in the macromolecule primary sequence.

17. The method as defined in claim 12 wherein the input vector for each atom comprises one or more natural properties of the atom or of a portion of the macromolecule containing the atom.

18. The method as defined in claim 17 wherein the portion containing the atom is one of an amino acid, a carbohydrate residue, or a nucleic acid.

19. The method as defined in claim 1, wherein the training set comprises more than one permuted initialized structure for a given macromolecule of a known primary sequence.

20. The method as defined in claim 2 wherein in step e) the initialized structure for the new macromolecule is defined using a genetic algorithm from a series of candidate structures.

21. A system for modeling the structure of a macromolecule based on the primary sequence of that macromolecule, the system comprising:
a memory for storing a training set of known macromolecules, wherein each known macromolecule of the training set has a known structure and a known primary sequence;
a processor module for:
a) determining an initialized structure for each known macromolecule of the training set based on its primary sequence;
b) for each known macromolecule of the training set, defining a corresponding projected folding path comprising a progression of n projected macromolecule states, beginning with the initialized structure and ending with the known structure, wherein n is a positive integer greater than 2, wherein each macromolecule state in the n macromolecule states has a corresponding primary sequence, and a state-specific projected structure;
c) providing a function operable to, for each known macromolecule of the training set, define a corresponding modeled folding path approximating the corresponding projected folding path, wherein
i) the corresponding modeled folding path comprises a progression of n modeled macromolecule states, beginning from the initialized structure and ending with the known structure,
ii) each modeled macromolecule state in the n macromolecule states has the primary sequence and a state-specific modeled structure, and
iii) the function is operable to, for each modeled macromolecule state progression of n modeled macromolecule states except the last modeled macromolecule state, translate the state-specific structure of any macromolecule state in the corresponding folding path into the state-specific structure of the immediately following macromolecule state in the progression.

22. The system as defined in claim 21 wherein
the memory is further operable to store a new macromolecule and a known primary sequence for the new macromolecule; and
the processor module is further operable to determine an initialized structure for the new macromolecule, and then apply the function to the known primary sequence and the initialized structure for the new macromolecule to determine the structure of the new macromolecule.

23. A computer program product for configuring a computer system to predict the structure of a macromolecule based on the primary sequence of the macromolecule, the computer program product comprising:
a recording medium;
a function saved on the recording medium for predicting the structure of the macromolecule using a training set of macromolecules wherein the function has been generated by a method comprising:
a) defining an initialized structure for each known macromolecule of the training set based on its primary sequence;
b) for each known macromolecule of the training set, defining a corresponding projected folding path comprising a progression of n projected macromolecule states, beginning with the initialized structure and ending with the known structure, wherein n is a positive integer greater than 2, wherein each macromolecule state in the n macromolecule states has a corresponding primary sequence and a state-specific projected structure;
c) providing a function operable to, for each known macromolecule of the training set, define a corresponding modeled folding path approximating the corresponding projected folding path, wherein
i) the corresponding modeled folding path comprises a progression of n modeled macromolecule states, beginning from the initialized structure and ending with the known structure,
ii) each modeled macromolecule state in the n macromolecule states has the primary sequence and a state-specific modeled structure, and
iii) the function is operable to, for each modeled macromolecule state progression of n modeled macromolecule states except the last modeled macromolecule state, translate the state-specific structure of any macromolecule state in the corresponding folding path into the state-specific structure of the immediately following macromolecule state in the progression.
